(19) United States
(12) Patent Application Publication
(10) Pub. No.: US 2008/0289951 A1
(43) Pub. Date: Nov. 27, 2008

(54) Thermochemical Cycle for Production of Hydrogen and/or Oxygen Via Water Splitting Processes

(76) Inventors: Cunping Huang, Cocoa, FL (US); Ali Tabatabaie-Raissi, Melbourne, FL (US); Nazim Muradov, Melbourne, FL (US)

Correspondence Address: DARBY & DARBY P.C., P.O. BOX 770, Church Street Station, New York, NY, 10008-0770, US

(21) Appl. No.: 12/092,674

(22) PCT Filed: Jun. 27, 2006
(86) PCT No.: PCT/US06/24865

§ 371 Date: May 5, 2008

Related U.S. Application Data
(60) Provisional application No. 60/694,273, filed on Jun. 27, 2005.

(51) Int. Cl. C01B 17/44; C01B 3/54; C01B 13/02; C01B 3/08

(52) U.S. Cl. 204/157.52; 423/658.2; 423/657; 423/579; 422/186.3; 422/129; 422/187

(57) ABSTRACT

A method for the production of hydrogen via thermochemical water splitting includes the steps of providing an ammonium sulfite compound, dissolving the ammonium sulfite in water, and oxidizing the aqueous ammonium sulfite solution, wherein hydrogen is produced as a water reduction product associated with the oxidation. If purified air is used instead for the oxidation of aqueous ammonium sulfite solution, the method produces oxygen from the purified air. In a preferred embodiment of the invention, the oxidation is a photooxidation. Light for the photoxidation can be provide by a direct light source, such as solar energy, or indirectly from conversion of electrical energy to light, such as using a UV or visible light lamp. Electrical energy can be provided by a variety of sources, including low cost sources comprising wind driven, water driven (hydroelectric), or nuclear power.

### FIELD OF THE INVENTION

The invention relates to the thermochemical generation of hydrogen and/or oxygen from water using a hybrid sulfur-ammonia cycle. The cycle can also be employed for the production of oxygen from air.

### BACKGROUND OF THE INVENTION

One of the leading alternatives to current fossil-based transportation fuels is hydrogen (H₂). H₂ satisfies energy needs from transportation to electric power generation, is least polluting, and lends itself to distributed production anywhere. H₂ is currently the primary fuel used in most fuel cell systems. Fuel cells are being developed for a variety of applications including distributed energy use, backup power generation, as an alternative to batteries for portable power source for consumer electronics, and in automobile power plants. However, H₂ is not an energy source; rather an energy carrier since H₂ must be produced using primary energy sources, such as fossil fuels, nuclear and solar energy.

H₂ can be produced from many feedstocks. For the reasons of availability, environmental acceptability and long-term energy security, it is highly desirable to produce H₂ from renewable non-carbonaceous feedstocks and primary energy sources—e.g., water and solar energy. However, to date, the development of a cost-effective and energy efficient process for generating H₂ from water using solar energy has remained a challenge hindering the realization of the future H₂ economy.

Splitting water (H₂O) for hydrogen production can be accomplished by direct thermolysis, electrolysis, photocatalysis, or photoelectrocatalysis of H₂O. Obstacles to direct water splitting are that thermolysis requires very high temperatures (i.e. ΔH=285.9 kJ/mol, T>2500° C.) and problem with hydrogen (H₂) and oxygen (O₂) recombination. Electrolysis requires ΔE>1.23 V and is highly costly due to a need for Pt electrodes. Photocatalysis requires high band gap E_{g}>3.0 eV material as catalyst and plagued with poor solar UV availability and problems with the H₂ and O₂ recombination. Photoelectrocatalysis requires bias voltage and the efficiency of the photocatalysts available are low.

Thermochemical water splitting cycles (TCWSCs) offer an alternative to direct water splitting. TCWSCs employ two or more chemical reactions forming a closed cycle wherein the overall reaction is: H₂O═H₂+½O₂. Typically, heat is the primary energy input. The basic Principle with the use of TCWSCs is to break down the total water splitting energy required into several steps with each step requiring only a part of the total energy necessary for water decomposition (ΔH=285.9 kJ/mol).

Pseudo TCWSCs have been looked at before that include: metal (M)/metal oxide (MO) systems such as MₓO_{y}=xM+y/2O₂; ΔH₁>ΔH_{w}; (M=Zn, Li, Na, Mg, K, Ca, etc.), and xM+yH₂O=MₓO_{y}+yH₂; ΔG<0, as well as the CO₂/CO system: CO₂═CO+½CO; ΔH₁>ΔH_{w}, and CO+H₂O═H₂+CO₂; ΔG<0. For these processes, the oxygen production step is tougher to carry out than direct H₂O splitting.

There are three basic steps of any TCWSC: 1) H₂ production; ΔH₁, 2) O₂ production; ΔH₂, and 3) separation (ΔHₛ) and H₂O pumping (ΔE). The efficiency of a TCWSC will be low if: ΔH₁˜ΔH_{w}>>ΔH₂; or ΔH₂˜ΔH_{w}>>ΔH₁, and will be high whenever: ΔH₁˜ΔH₂.

In order to achieve high cycle efficiency, the energy requirements for two major steps (i.e. hydrogen and oxygen production) should be close. In the sulfur-family TCWSCs, the thermal decomposition of H₂SO₄ (for oxygen production) is involved which is highly endodermic consuming 69% of the total water splitting energy required. In the solar driven TCWSCs, this step can be accomplished by consuming the thermal energy portion of solar radiation while the remaining 31% of solar spectrum can be utilized in the H₂ production step. Therefore, matching a TCWSC to the solar spectrum is the critical element of the design of a superior water-splitting cycle. In other words, hydrogen generating step of a prospective solar thermochemical water splitting cycle should be able to utilize ΔE=0.52 V or about 33% of the total ΔE needed for the H₂O splitting (about 1.52 V by water electrolysis). On the other hand, the oxygen production step of the cycle should be able to utilize the remaining 67% of the total energy needed for splitting water. For the solar spectrum, the wavelength border or split for this energy partitioning is at about 1=650 nm (i.e. 33% photonic energy falls in the wavelength region below 650 nm while 67% of solar thermal energy is at wavelengths longer than 650 nm). In some thermochemical water splitting cycles such as the Westinghouse hybrid cycle, the energy required for hydrogen evolution is low (only 0.17 V or about 1/10 of the total energy needed for water splitting). This mismatch of energy required for evolving H₂ and O₂ steps of this and some other disclosed cycles renders these water splitting cycles less efficient for hydrogen production.

### SUMMARY OF THE INVENTION

A method for the production of H₂ via thermochemical water splitting includes the steps of providing an ammonium sulfite compound, dissolving the ammonium sulfite in water, and oxidizing the ammonium sulfite in the presence of water, wherein H₂ is produced as a reduction product associated with the oxidation of ammonium sulfite. The reaction temperature for the oxidizing step is generally between 275 K and 375 K, and is preferably between 275 K and 325 K.

In one embodiment, a catalyst is included. The catalyst can be selected from metal sulfides such as CdS, CdSe, CdTe, ZnS, Cu₂S, RuS₂ and mixtures thereof, metal oxides such as TiO₂, RuO₂, and WO₃, and doped transition metal oxides such as Pt/CdS, Pt/FiO₂ and Pt/TiO₂₋ₓNₓ. Other catalysts include metal sulfides together with particles comprising at least one noble metal selected from the group consisting of Pt, Pd, Ir, Ag, Au, Rh and Ru.

In one embodiment the oxidizing step comprises photooxidation. UV and/or visible light for the photooxidation can be provided by solar radiation. In this embodiment the method can further comprise the steps of splitting the infrared portion of solar radiation from its UV and visible light portions, directing the UV and visible light portions of the solar radiation into a photocatalytic reactor in order to drive the oxidizing step of the cycle, and directing the infrared portion of solar spectrum into a thermocatalytic reactor to provide heat required for the decomposition of ammonium sulfate (NH₄)₂SO₄(aq) and sulfuric acid H₂SO₄(l) and generation of oxygen.

In one embodiment the oxidizing step proceeds exclusive of any catalyst, wherein the oxidizing step is performed in the presence of UV light. For example, the oxidizing step can comprise photooxidation, where electrical energy is used to generate UV and drive photooxidation reaction The electricity may come from off peak electricity, nuclear power, hydroelectric power, photovoltaic cells or wind turbines.

The method is preferably practiced as a closed cycle. When an oxidation product is ammonium sulfate, the method can further comprising the steps of thermally decomposing the ammonium sulfate to ammonia and sulfur dioxide and oxygen, and recovering and recycling the ammonia and sulfur dioxide to react with water to regenerate the ammonium sulfite.

In another embodiment of the invention, a method of generating oxygen (O₂) is provided. The method comprises the steps of providing an ammonium sulfite compound, oxidizing the ammonium sulfite to produce ammonium sulfate in the presence of air, wherein O₂ is separated from nitrogen in the air. A reaction temperature for the oxidizing step is generally between 275 K and 375 K and is preferably between 275 K and 325 K.

Ammonium sulfate can be decomposed into ammonia, water, sulfur dioxide, and oxygen. Separating oxygen from sulfur dioxide, the process can generate oxygen from air.

A system for generating hydrogen (H₂) comprises a reaction vessel having an aqueous ammonium sulfite solution therein, at least one energy source coupled to the reaction vessel for providing energy to drive the oxidation of ammonium sulfite, wherein hydrogen is produced, and collected. The energy source can be provided exclusively by electricity. In another embodiment a photocatalyst is needed, wherein the energy source comprises solar radiation or a UV (e.g. mercury lamp) or visible (e.g. xenox lamp) light source. In this embodiment the system can include a broadband reflective coating for splitting the infrared portion from the UV and visible light portions of the solar radiation, and optics for directing the UV and visible light portions to drive the ammonium sulfite oxidation reaction, and optics for directing said infrared portion to provide heat required for decomposition of ammonium sulfate and sulfuric acid.

### BRIEF DESCRIPTION OF THE DRAWINGS

There is shown in the drawings embodiments which are presently preferred, it being understood, however, that the invention can be embodied in other forms without departing from the spirit or essential attributes thereof.

FIG. 1(a) is a simple flow diagram for an exemplary cycle according to the invention.

FIG. 1(b) shows the schematic including flow dynamics of an exemplary sulfur-ammonia closed cycle-based hydrogen generation system according to the invention.

FIG. 2 is a schematic flow diagram of a solar powered sulfur ammonia (S—NH₃) thermochemical water splitting cycle according to the invention which includes a broadband anti-reflective coating for splitting solar radiation into the photonic (UV and visible light) portion and the infrared portion.

FIG. 3 is a flow diagram for oxygen production from air via a sulfur ammonia thermochemical cycle according to the invention.

FIG. 4 is a schematic diagram depicting a batch reactor for the photolytic decomposition of aqueous sodium sulfide solution (light source: a 60-W low-pressure mercury vapor lamp, LPML).

FIG. 5 is a diagram depicting the rate of H₂ evolution during photocatalytic oxidation of aqueous ammonium sulfite in the presence of CdS/Pt photocatalyst in a quartz flask photo reactor (250 mL of 0.5 M (NH₄)₂SO₃ solution, 1 kW xenon arc lamp).

FIG. 6 is a diagram depicting the photolytic production of H₂ from ammonium sulfite aqueous solution subject to UV irradiation (500 mL of 0.5 M aqueous (NH₄)₂SO₃ solution, 60-W LPML).

FIG. 7 is a diagram depicting the rate of H₂ production by visible light photolysis (without the presence of a photocatalyst) of 0.25 M aqueous (NH₄)₂SO₃ solution.

FIG. 8 is a diagram depicting the rate of hydrogen production from 0.5 M aqueous ammonium sulfite solution in the presence of Pt/CdS as a visible light photocatalyst.

FIG. 9 is a diagram depicting the TG/DTA of 0.5 M aqueous ammonium sulfite solution (solid & dash lines indicate percentage of the sample weight remaining & heat flow, respectively).

FIG. 10 is a diagram depicting the TG/DTA of 0.5 M aqueous ammonium sulfate solution.

FIG. 11 is a diagram depicting the TG/DTA of the photocatalytic oxidation products of an aqueous ammonium sulfite solution (after 64 hrs of operation).

FIG. 12 is a diagram depicting the TG/DTA of a mixture of ammonium sulfite and ammonium sulfate aqueous solution with total combined concentration of 0.5 M (sulfite:sulfate=1:1).

FIG. 13 is a diagram depicting the TG/DTA of a mixture of ammonium sulfite and ammonium sulfate with total combined concentration of 0.5 M (sulfite:sulfate=2:1).

FIG. 14 is a diagram depicting the TG/DTA of a mixture of ammonium sulfite and ammonium sulfate aqueous solution with total combined concentration of 0.5 M (sulfite:sulfate=1:2).

FIG. 15 is a diagram depicting the UV-VIS absorbance spectra of sulfate, sulfite, and dithionate species and the reaction product of aqueous ammonium sulfite photocatalytic oxidation.

### DETAILED DESCRIPTION OF THE INVENTION

A first embodiment of the invention is a method for the production of H₂ via a hybrid sulfur-ammonia (S—NH₃) thermochemical water splitting cycle. The method comprises the steps of providing an ammonium sulfite compound, dissolving the ammonium sulfite with water, and oxidizing the aqueous ammonium sulfite solution, wherein H₂ is produced as a water reduction product associated with the oxidation of ammonium sulfite. As used herein, although the ammonium sulfite compound referred to herein is generally (NH₄)₂SO₃, it may be possible to utilize other ammonium sulfites, such as ammonium bisulfite (NH₄HSO₃) In a preferred embodiment of the invention, the oxidation is a photo oxidation reaction. Light for the photoxidation can be provide by a direct light source, such as solar energy, or indirectly from conversion of electrical energy to light, such as using a UV or visible light lamp. Electrical energy can be provided by a variety of sources, including low cost sources comprising wind driven, water driven (hydroelectric), or nuclear power.

The inventive method is major modification and significant improvement over the Westinghouse hybrid cycle (WHC). The well known WHC is a two-step hybrid thermochemical water splitting cycle which includes the following reactions:

SO₂+H₂O→H₂+H₂SO₄ (Electrolytic step; 350 K)

H₂SO₄(l)→SO₂(g)+H₂O(g)+½O₂(g) (Thermochemical step; 1123 K)

The advantages of Westinghouse cycle are that it is an all-fluid cycle and constitutes only two reactions. The high temperature thermochemical step accepts heat over a large span of temperature that makes matching the cycle to the sensible heat of a power source more practical. The side reactions for the WHC are not significant and the thermodynamic properties of all chemical species involved are known. The main disadvantage of the WHC is just that, it is a hybrid cycle and as such suffers from the scale-up issues inherent to all electrochemical systems. Electrochemical plants can only be scaled-up in modular fashion. Furthermore, cycle has been studied extensively by both Westinghouse and others but no new improvement have been introduced since the last Westinghouse flowsheet was devised until the present modification. Also, the low solubility of SO₂ in water renders the hydrogen production step not very efficient. The low water solubility of SO₂ makes separation of H₂SO₄ from water after the thermochemical step an energy intensive process. Moreover, low pH of SO₂ solution can lead to the generation of elemental sulfur, further reducing the overall process efficiency.

Modifying the WHC to incorporate ammonia according to the invention makes it possible to attain very high hydrogen (or oxygen as described below) production efficiencies, thus reducing the overall process costs. Several embodiments are described for the oxidation of aqueous ammonium sulfite, most of which can be performed at or near room temperatures, making the inventive method more efficient and flexible, and highly compatible for interfacing with a wide range of external power sources.

By modifying the WHC cycle to employ ammonia-sulfur compounds instead of SO₂, problems associated with SO₂ are largely eliminated. The invention converts SO₂ into SO₃²⁻ which can be handled in the aqueous phase rather than the need to separate it into the gaseous phase as in the WHC. Both solubility and solution pH of (NH₄)₂SO₃ are substantially higher than those of the aqueous SO₂ solution used in the WHC. High solubility of (NH₄)₂SO₃ not only increases the efficiency of SO₂ electrolysis but also makes simple room temperature and ambient pressure operation possible. Significantly, unlike SO₂, (NH₄)₂SO₃ solution can be either electrolytically, photolytically, photoelectrochemically or photocatalytically oxidized (at near room temperatures and one atm pressure conditions) to generate hydrogen as follows:

(NH₄)₂SO₃+H₂O+electricity=H₂+(NH₄)₂SO₄ (1)

(NH₄)₂SO₃+H₂O+photocatalyst+sunlight=H₂+(NH₄)₂SO₄ (2)

(NH₄)₂SO₃+H₂O+UV light=H₂+(NH₄)₂SO₄ (3)

(NH₄)₂SO₃+H₂O+TiO₂+UV light=H₂+(NH₄)₂SO₄ (4)

(NH₄)₂SO₃+H₂O+photoelectrode+sunlight=H₂+(NH₄)₂SO₄ (5)

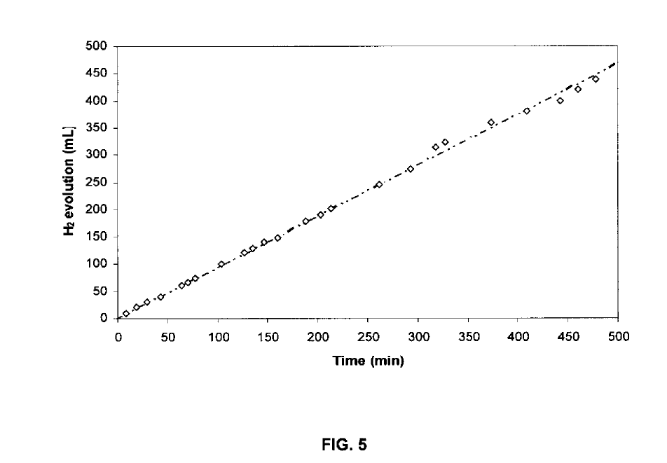

These five possible alternative processes for the oxidation of aqueous ammonium sulfite make the sulfur-ammonia water splitting cycle more practical than the conventional WHC for hydrogen production because of its flexibility in employing a variety of input energy options. Reactions (1), (3) and (4) can be advantageously used when low-cost electric power is available, such as that available from wind or hydroelectric. Reaction (1) is a highly efficient electrochemical oxidation process with efficiencies exceeding 75%. Reactions (3) and (4) require conversion of electricity to UV (or visible) light prior to photochemical oxidization of (NH₄)₂SO₃. However, these reactions are very efficient in photolytic oxidation of ammonium sulfite because light from a suitable lamp can provide radiation in a precise wavelength range that can be directly taken up by the solution with higher efficiencies. Reaction (3) does not require any catalyst, simplifying the cycle by eliminating the separation step required to remove the photocatalyst powder from the reaction products. Results shown in FIG. 5 depict very high efficiency for hydrogen production compared to that of CdS and CdS/Pt photocatalysts. Also, as indicated by Reaction (4), UV light and a highly efficient photocatalyst, for example, TiO₂, can be used together for generating hydrogen by photooxidation of (NH₄)₂SO₃. Visible light can also be used for the photooxidation, such as when the catalyst is CdS and the like having a narrow bandgap energy that can be activated with visible light. Reactions (3) and (5) can also be employed in conjunction with solar photons. Significantly, as noted above, Reactions (1) to (5) can all be performed at near room temperatures and ambient pressure.

Photocatalysts used in Reaction (3) include most low bandgap semiconductor photocatalysts, such as CdS, CdSe, CdTe, RuS₂, RuO₂ and the solid solution of CdSₓSe₁₋ₓ, CdSₓTe₁₋ₓ and CdSₓSeyTe_{1-x-y}. Photoelectrodes useful for the practice of this invention according to Reaction (5) include metals (e.g. Pt) or carbon coated with nanoparticles of semiconductor photocatalysts: RuS₂, RuO₂, Ru₁₋ₓFeₓS₂, CdS, CdSe, CdTe, TiO₂₋ₓN_{xa, TiO}₂, among others. Photocatalysts can be doped with noble metals such as Pt, Ru, Pd, Os, Ir, Au and Ag or base and/or other metals such as Cu, Cr, Fe or Zr.

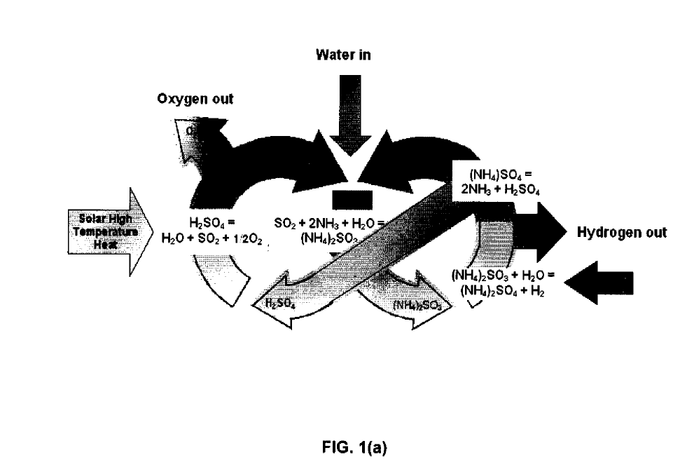

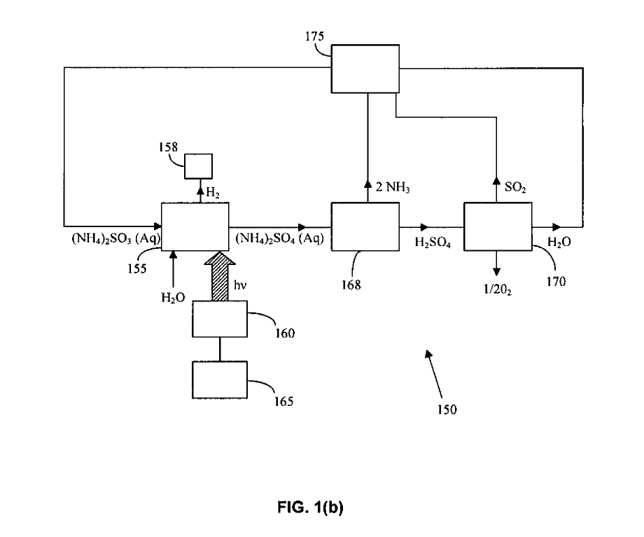

FIG. 1(a) provides a simple flow diagram showing four (4) steps believed to be taking place for an exemplary sulfur-ammonia cycle for the production of hydrogen according to the invention. The exemplary sulfur-ammonia cycle includes the following steps shown with the preferred reaction temperatures for the respective reactions with the overall reaction being the splitting of water into hydrogen and oxygen. None of the compounds involved in the cycle are consumed except water:

| | |
|---|---|
| SO₂(g) + 2NH₃(g) + H₂O(l) → | 300K (chemical absorption 6) |
| (NH₄)₂SO₃(aq) | |
| (NH₄)₂SO₃(aq) + H₂O→ | 300K (photochemical step 7) |
| (NH₄)₂SO₄(aq) + H₂(g) | |
| (NH₄)₂SO₄(aq)→2NH₃(g) + | 525K (thermochemical step 8) |
| H₂SO₄(l) | |
| H₂SO₄(l) → SO₂(g) + | 1125K (thermochemical step 9) |
| H₂O(g) + ½O₂(g) | |
| Overall reaction: H₂O = H₂(g) + | |
| ½O₂(g) | |

A key step in the inventive method is the production of H₂ and ammonium sulfate via oxidation of an aqueous ammonium sulfite solution, for which five (5) alternative embodiments are provided above (Reactions 1-5). The cycle uses the ammonium sulfate that is generated and thermally decomposes it into oxygen, ammonia and SO₂. Ammonia and sulfur dioxide are then recovered and recycled, and subsequently reacted via Reaction (6) with water to regenerate the ammonium sulfite. Reactions (6) and (9) are well understood and can be carried out using conventional chemical processes.

FIG. 1(b) shows the schematic including flow dynamics of an exemplary sulfur-ammonia closed cycle-based hydrogen generation system 150 according to the invention. System includes photoreactor 155. Photoreactor 155 receives light from light source 160 powered by an electrical generator 165, such as based on nuclear power, hydroelectric power, or wind driven power. Hydrogen is generated (Reaction 7) by photoreactor according to (NH₄)₂SO₃(aq)+H₂O→(NH₄)₂SO₄(aq)+H₂(g), with H₂(g) collected by structure for collecting 158. The (NH₄)₂SO₄(aq) (Reaction 8) is then thermochemically separated into 2NH₃(g)+H₂SO₄(l) in reactor 168. A thermochemical step is performed by reactor 170 (Reaction 9) which decomposes H₂SO₄(l)→SO₂(g)+H₂O(g)+½O₂(g). Chemical absorption takes place at reactor 175 (Reaction 6) SO₂(g)+2NH₃(g)+H₂O(l)→(NH₄)₂SO₃(aq) thus regenerating (NH₄)₂SO₃(aq) used by photoreactor 155 using solely reaction products.

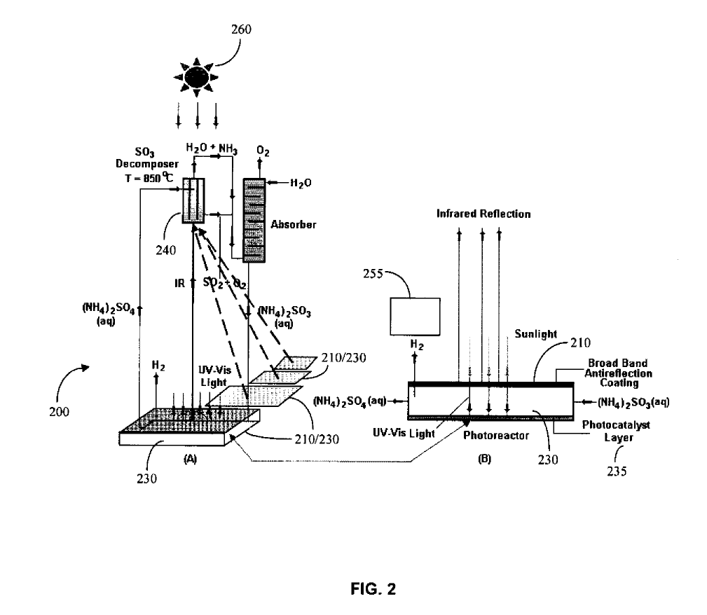

FIG. 2 is a schematic flow diagram of a solar powered S—NH₃ thermochemical water splitting system 200 according to the invention. System 200 includes a structure for separating 210 the photonic (UV and visible light) portion of the solar resource 260 from the infrared portion. With this approach, the photonic portion of the solar radiation can be made available for the photocatalytic reactor 230 having a photocatalyst layer 235 which conducts the photocatalytic hydrogen production step of the S—NH₃ cycle while the infrared portion is used to provide heat for one or both of the thermochemical decomposition processes.

A broadband antireflection coating 210 can be used for this purpose. Such a coating provides very low reflectance over a broad range of wavelengths within the UV and visible spectra. With this approach, the infrared (thermal) portion of the solar resource is resolved by the receiver/photoreactor units 210/230 in the mirror field and concentrated into a high temperature thermocatalytic reactor 240 located within the tower for the decomposition of (NH₄)₂SO₄ and sulfuric acid to produce oxygen. The photonic (UV and visible light) portion of the solar light is utilized for the hydrogen production via photocatalytic oxidation of aqueous (NH₄)₂SO₃ solution into (NH₄)₂SO₄ while water is reduced into hydrogen. Hydrogen is collected by structure for collecting H₂ 255. The utilization of both thermal heat and photonic energy increases the solar to hydrogen energy conversion efficiency of the cycle (absorbed light to chemical energy of hydrogen) by up to 50% or more as compared to known cycles.

In a related embodiment of the invention, oxygen is produced via a sulfur ammonia thermochemical cycle according to the invention. Thus, the sulfur ammonia thermochemical cycle is extended beyond production of hydrogen via water splitting, to the generation of oxygen from purified air by oxidizing a sulfur ammonium compound such as aqueous ammonium sulfite solution in the presence of purified air. This process can be described in the following reactions believed to be occurring, provided along with their nominal reaction temperatures:

| | | |
|---|---|---|
| SO₂(g) + 2NH₃(g) + H₂O(l) → | 300K | (10) |
| (NH₄)₂SO₃(aq) | (chemical absorption step) | |
| (NH₄)₂SO₃(aq) + | 300K | (11) |
| Air(N₂ + O₂)→(NH₄)₂SO₄(aq) + N₂ | (oxidation step) | |
| (NH₄)₂SO₄(aq) →2NH₃(g) + | 525K | (12) |
| H₂SO₄(l) | (thermochemical step) | |
| H₂SO₄(l) → SO₂(g) + | 1125K | (13) |
| H₂O(g) + ½O₂(g) | (thermochemical step) | |
| Overall reaction: Air = N₂ + O₂ | | |

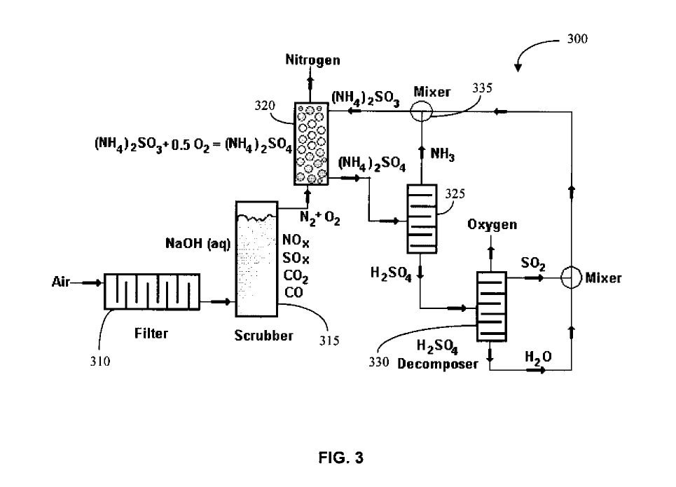

FIG. 3 shows a flow diagram and simplified implementing system 300 for oxygen production via a sulfur ammonia thermochemical cycle according to the invention. An air stream is preferably fed into a filter 310 to filter solid dust and then passed through a scrubber 315 where trace amounts of impurity gases, such as carbon monoxide (CO), carbon dioxide (CO₂), nitrogen oxides (NOₓ) and sulfur oxides (SOₓ), are dissolved in an alkaline solution. The purified air (N₂ plus O₂) is then inlet to a reactor 320 to oxidize ammonium sulfite ((NH₄)₂SO₃) to form ammonium sulfate ((NH₄)₂SO₄) at or near room temperature and ambient pressure. Through the consumption of oxygen during the oxidation, nitrogen is thus separated from oxygen. The ammonium sulfate stream passes through a low temperature decomposer 325 to separate ammonia (NH₃) sulfuric acid (H₂SO₄) at a nominal temperature of 525 K (Reaction 12). Sulfuric acid is then decomposed into oxygen (O₂), sulfur dioxide (SO₂) and water in a high temperature decomposer 330 at a nominal temperature of 1125 K (Reaction 13). After oxygen (O₂) is separated, sulfur dioxide (SO₂), water and ammonia (NH₃) are mixed by mixer 335 to form an aqueous ammonium sulfite ((NH₃)₂SO₃) solution at ambient temperature (Reaction 10) that is sent to the reactor 320 for the oxidation to ammonium sulfate thus closing the cycle. The overall reaction of the S—NH₃ thermochemical cycle is the generation of oxygen (O₂) from air.

A major advantage of this oxygen generation process is that heat is the primary energy requirement in the process which is mainly used in the decomposition of sulfuric acid for oxygen production (Reaction 13). For example, the inventive process can be advantageously applied in metallurgical industries where large quantities of oxygen are needed for the manufacture of iron and steel. Such metallurgic processes are known to generate large amounts of high temperature “waste” heat. Using the invention, the “waste” heat can be utilized as a heat source to provide the oxygen (from the air) required for the manufacture of iron or steel.

Experiments have been carried out for the oxidation step, Reaction (11). The results obtained demonstrate that aqueous ammonium sulfite solutions can be oxidized by air at ambient temperature and pressure to produce ammonium sulfate, thus extracting oxygen from the other component of purified air (nitrogen). The oxidation was found to proceed at a relatively fast rate at room temperature without the need for any added catalysts.

The present invention can significantly contribute to enhancing the quality of the environment by allowing hydrogen to become more competitive with hydrocarbon-based fuels. As noted in the Background, due to reasons including environmental acceptability it is highly desirable to produce H₂ from renewable non-carbonaceous feedstocks and energy sources. However, prior to the invention lack of a cost-effective and energy efficient process for generating H₂ from non-carbonaceous energy sources has hindered progress toward realization of the future hydrogen economy. Through providing a cost-effective and energy efficient process for generating H₂ from non-carbonaceous feedstocks and energy sources the present invention will advance the hydrogen economy and thus enhance the quality of the environment by allowing hydrogen to begin replacing hydrocarbon-based fuels.

### EXAMPLES

It should be understood that the Examples described below are provided for illustrative purposes only and do not in any way define the scope of the invention.

In order to verify the photochemical hydrogen generation step shown in Reaction (7), a series of experiments involving visible-light photocatalytic production of H₂ from aqueous ammonium sulfite solutions were carried out. Ammonium sulfite (Aldrich Chemicals) was used without further purification. A 250 mL and 0.25 M (or 0.50 M) aqueous slurry solution of ammonium sulfite and photocatalysts comprising 0.50 g of cadmium sulfide (CdS) powder (Alfa Aesar) and 2.0 mL poly platinum (as a photocatalyst) which was poured into a quartz photoreactor. The volume of hydrogen produced from the solution was measured by water displacement method. A Gas Chromatograph (GC) equipped with a thermal conductivity detector and argon carrier gas was used to determine the purity of product hydrogen. A solar simulator was employed equipped with a 1000-Watt xenon arc lamp (Schoeffel Instrument Corp.) and a water filter to absorb the undesirable excess IR radiation from the lamp. The spectral power distribution of light emanating from the xenon arc lamp was used as a solar simulator. The Pyrex glass window was found to absorb most of ultraviolet portion of the light generated by the xenon arc lamp. Radiation from the lamp at wavelengths greater than 800 nm is not utilized in the photocatalytic process and as such the light from the solar simulator used in the experiments provided a reasonable match to that of solar.

Two photoreactors were used for the photooxidation of ammonia sulfite aqueous solutions. One was a 250 mL quartz flask and the other used a Pyrex glass window to filter most of the ultraviolet light (λ<300 nm) emitted by the xenon arc lamp.

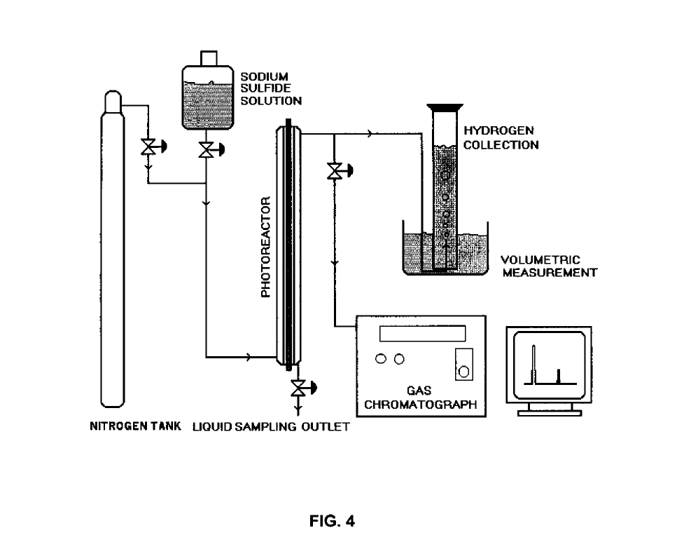

A series of experiments were conducted to study photolysis of ammonium sulfite aqueous solution using a 60 W low-pressure mercury vapor lamp (LPML) located within an annular batch reactor (500 mL) that contained 0.50 M aqueous ammonium sulfite. FIG. 4 depicts a schematic diagram of the LPML system used.

Qualitative analyses of sulfite and sulfate ions were made both by High Performance Liquid Chromatograph (HPLC) and a chemical analysis. This example introduces the analytic method of sulfite and sulfate ions by the formation of barium sulfate. Similar analyses were carried out on freshly prepared ammonium sulfite solutions (before they were used in the photocatalytic reaction) and after they were used in the photocatalytic experiments. The suspended photocatalyst powders were filtered out of the solution prior to analyses. 10 mL solutions were first diluted to 100 mL by adding distilled water and then their pH was adjusted to 1.00 by slowly adding hydrochloric acid to the solution. The acidification of the solution facilitates the decomposition of sulfite ions into sulfur dioxide according to: H₂SO₃═SO₂+H₂O. The solutions were purged with argon gas while stirring vigorously. Small quantities (approximately 2 mL) were periodically sampled from the solution and subjected to barium chloride test to determine the presence of sulfite ions. The purging times were also recorded. The solution remaining after each photochemical reaction was also purged with argon gas for the same length of time and subjected to the barium chloride analysis.

In the inventive method, ammonium sulfate, which is produced in the course of photocatalytic oxidation of sulfite ions, decomposes into ammonia gas as noted by Reaction (8). The ammonia gas is then recycled to the ammonium sulfite synthesis reactor and used to form (NH₄)₂SO₃. In the acid decomposition reactor, sulfuric acid is decomposed into sulfur dioxide and oxygen. Sulfur dioxide from the acid decomposition reactor is extracted and returned to the sulfite synthesis reactor where it combines with ammonia to form ammonium sulfite. A series of tests using a thermogravimetric/differential thermal analyzer (TG/DTA) instrument (Perkin Elmer Corp.) to determine the reaction kinetics and decomposition mechanisms of ammonium sulfate and ammonia sulfite solutions were also carried out. 0.50 M aqueous solutions of ammonium sulfite and ammonium sulfate were heated from 295 to 498 K at a rate of 1.0 K/min and from 498 to 653 K at a rate of 2.0 K/min. Furthermore, the prospects of separating ammonium sulfate from ammonium sulfite via TG/DTA analysis of mixed ammonium sulfite and sulfate solutions at a range of sulfite to sulfate ratios were also investigated.

During the photocatalytic oxidation of ammonium sulfite aqueous solutions, sulfite ions act as electron donors and consequently are oxidized to sulfate and/or dithionate ions, while water is reduced to hydrogen. FIG. 5 depicts the rate of hydrogen evolution during photocatalytic oxidation of aqueous ammonium sulfite in the presence of Pt/CdS photocatalyst. The GC analyses of the product gas showed that no species other than hydrogen were present. Results showed that, the amount of hydrogen produced increased linearly with the radiation dosage, indicating that no catalysts deactivation had occurred after 500 min of operation.

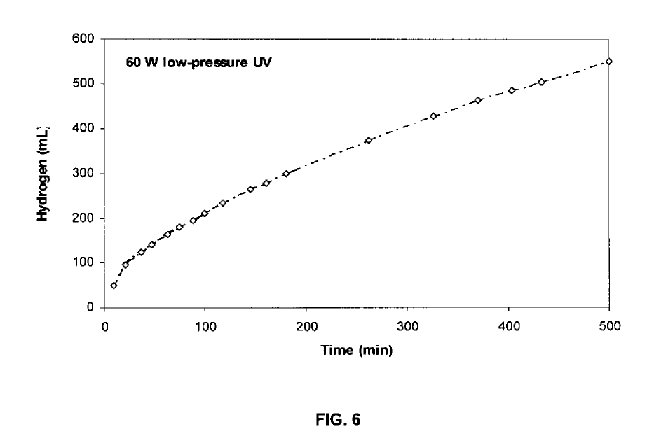

Ammonium sulfite can be also oxidized when irradiated with the UV light. FIG. 6 depicts the extent of hydrogen production by oxidation of aqueous solution of ammonium sulfite subject to UV light radiation. In this experiment, the solution was not stirred and it is possible that the hydrogen evolution rate may have been lower than otherwise possible due to poor ammonium sulfite and reaction products mass transfer to and from the illuminated region of the photoreactor, respectively.

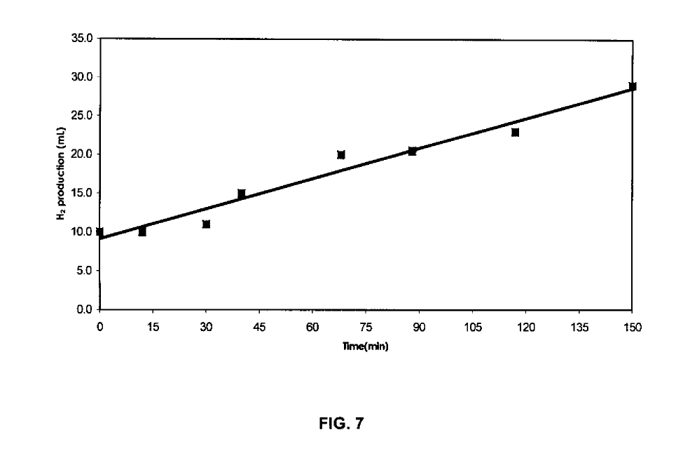

In another experiment, 250 mL of 0.5 M solution of ammonium sulfite was mixed with 0.5 g of CdS catalyst powder and added to a Pyrex photoreactor. Results of FIG. 7 indicate that the hydrogen evolution rates are low, only 15 mL of H₂ was generated after 2.5 hrs of operation. This can be explained by the fact that CdS by itself is not a good catalyst for facilitating H₂ production.

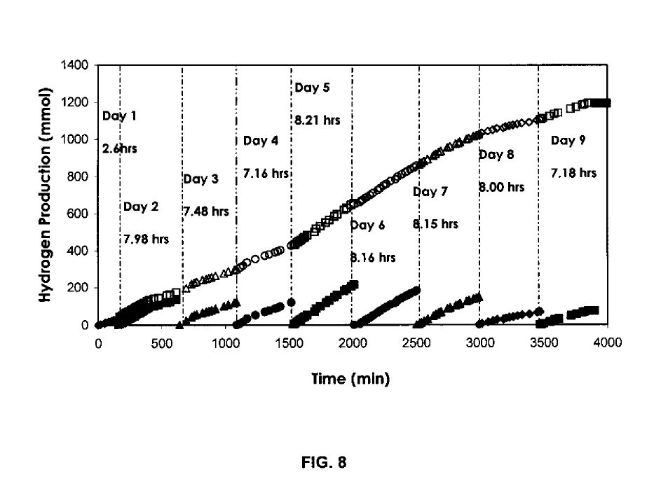

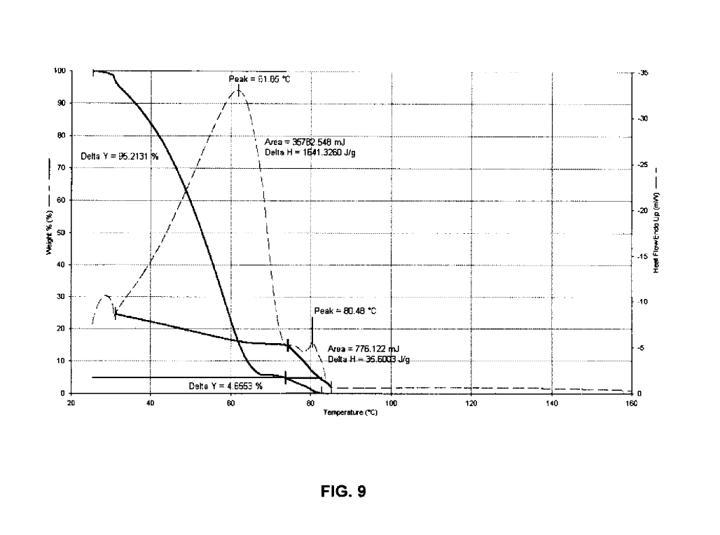

In this experiment, a 0.5 M solution of aqueous ammonium sulfite and 0.5 g of 1.0 wt % Pt on CdS catalyst were added into a Pyrex reactor. The experiment ran continuously for 9 days, subject to about 7 hrs of illumination each day. Results shown in FIG. 9 indicate that a total of 2.5 L of hydrogen gas was generated at the end of 9-day period. Compared to virgin, unplatinized CdS catalyst, the amount of hydrogen produced had increased substantially. The results of FIG. 8 indicate that solar photocatalytic oxidation of aqueous ammonium sulfite solution is feasible although the efficiency of H₂ production is somewhat lower than that from the UV irradiated photocatalytic or by UV-photolytic processes.

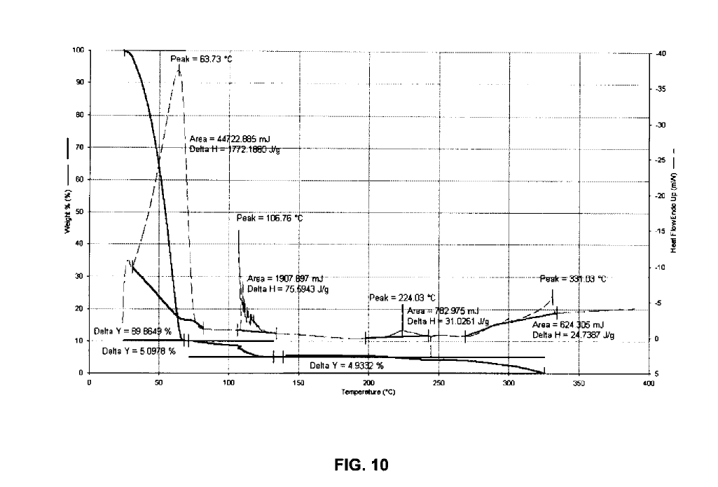

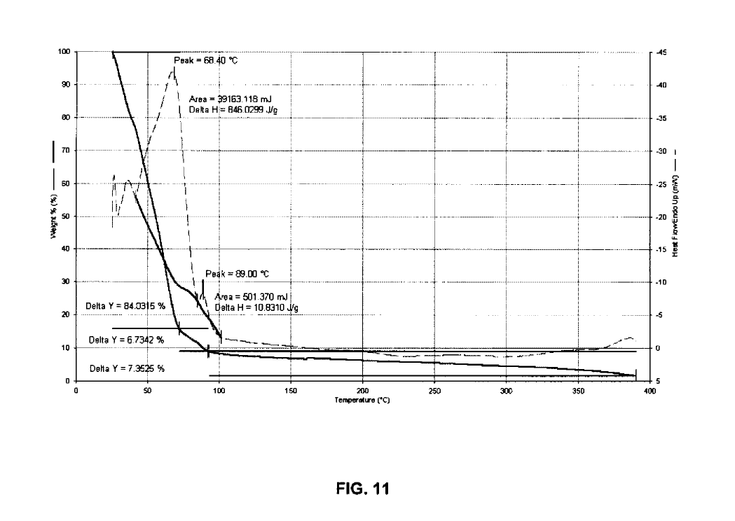

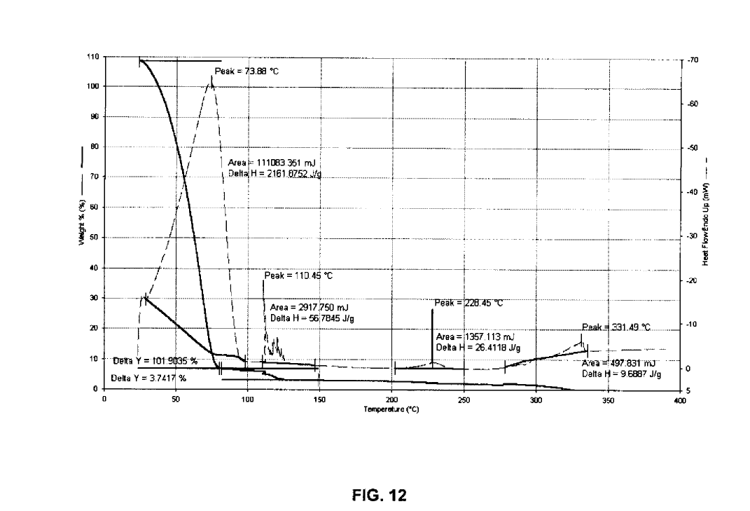

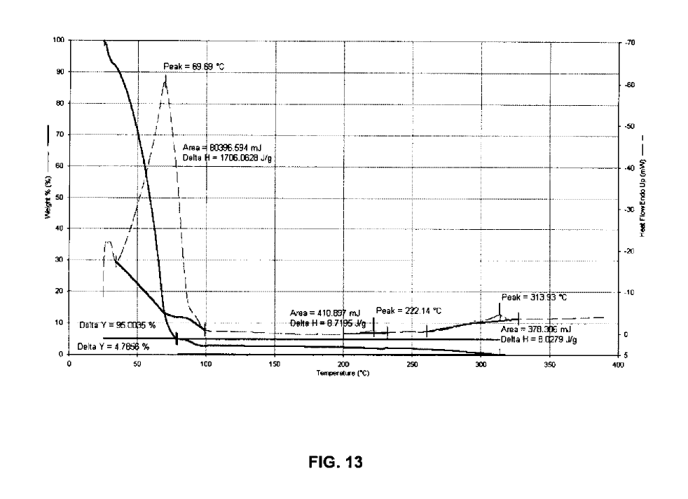

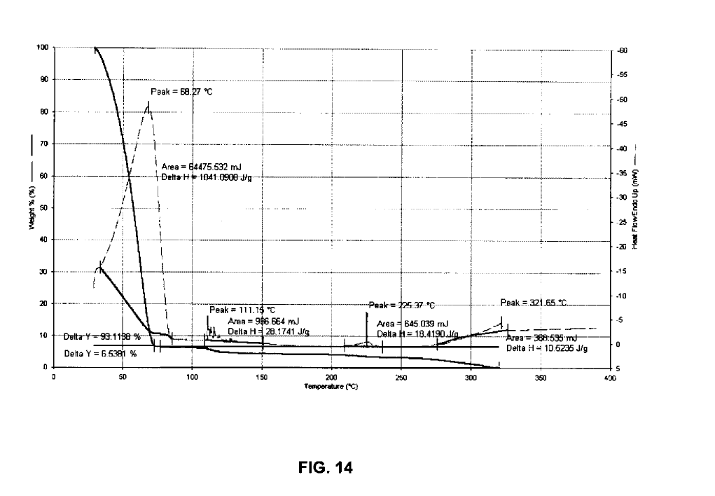

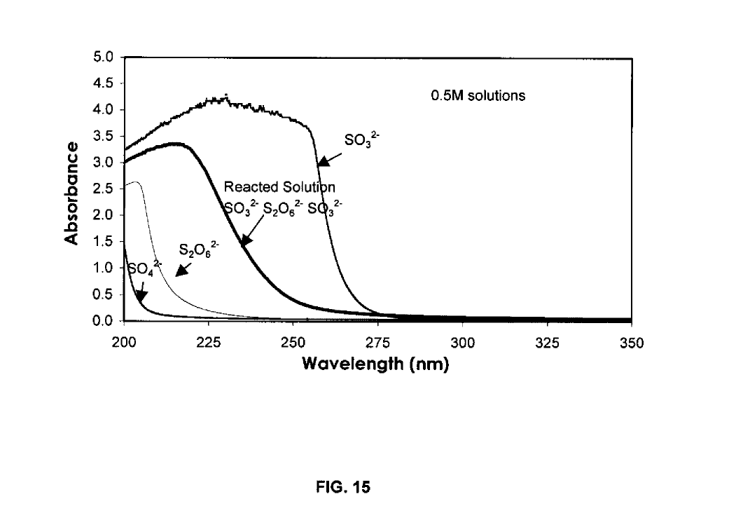

It is important to be able to efficiently recover and recycle ammonia gas generated during the ammonium sulfate thermochemical decomposition step (8) of the inventive method. It is also noted that the photocatalytic oxidation of ammonium sulfite aqueous solution generates, in addition to hydrogen and un-reacted (NH₄)₂SO₃, ammonium dithionate ((NH₄)₂S₂O₆) and ammonium sulfate as well. The decomposition patterns of (NH₄)₂SO₃ and (NH₄)₂SO₄ aqueous solutions were investigated by method of thermogravimetric/differential thermal analysis (TG/DTA). The results are depicted in FIGS. 9 to 14 and indicate that ammonia can be readily recovered from the decomposition products of these compounds in the temperature range of 355-623 K. Ammonium sulfite completely decomposes at 355 K (FIG. 10) while ammonium sulfate decomposition begins at 473 K and completed at 623 K (FIG. 11). FIG. 12 indicates that the products of photocatalytic oxidation of ammonium sulfite aqueous solution (after 64 hrs of irradiation) show a DTA peak at 362 K that is different from the ammonium sulfite decomposition DTA peak (at 353 K). This peak may very well be due to the ammonium dithionate decomposition. When heating the solution above 373 K, the extent of weight loss reaches 7.5%, indicating the occurrence of ammonium sulfate in the solution. This observation is in accord with the results from the UV-VIS analysis depicted in FIG. 15.

In order to verify the formation of ammonium dithionate (a dimer of ammonium sulfite) during photocatalytic reactions, a series of absorbance measurements were carried out using a UV-VIS spectrophotometer. The samples used for the analysis were, 0.5 M Na₂SO₃, 0.5 M Na₂SO₄, 0.5 M Na₂S₂O₆ (dithionate), 0.5 M (NH₄)₂SO₃, 0.5 M (NH₄)₂SO₄, and the products of photocatalytic oxidation of aqueous ammonium sulfite solution after 64 hrs of operation. First, it was observed that there was virtually no cation effect on the absorbance of the solutions, and both ammonium and sodium sulfite solutions had almost identical absorbance spectra. Results of FIG. 15 indicate that the absorption of the reacted sample falls between those of sulfite, dithionate and sulfate solutions, suggesting that the oxidized sulfite solution may contain a mixture of sulfite, dithionate and sulfate ions. The analysis of the photoreaction liquid product also revealed the presence of dithionate and sulfate ions. FIG. 15 may also suggest a sequence of oxidation reactions from SO₃²⁻ to S₂O₆²⁻ and finally to SO₄²⁻.

TG/DTA results of FIGS. 12-14 indicate that it is feasible to separate (NH₄)₂SO₃ from (NH₄)₂SO₄ in an aqueous solution within a wide range of temperatures.

This invention can be embodied in other forms without departing from the spirit or essential attributes thereof and, accordingly, reference should be had to the following claims rather than the foregoing specification as indicating the scope of the invention.

We claim:

1. A method of generating hydrogen (H₂), comprising the steps of:
providing an ammonium sulfite compound, and
oxidizing said ammonium sulfite in the presence of water, wherein H₂ is produced as a reduction product associated with said oxidizing.

2. The method of claim 1, wherein a reaction temperature for said oxidizing step is between 275 K and 375 K.

3. The method of claim 1, further comprising a catalyst, wherein said catalyst is selected from the group consisting of a metal sulfide selected from CdS, CdSe, CdTe, ZnS, Cu₂S, RuS₂ and mixtures thereof, a metal oxide selected from TiO₂, RuO₂, and WO₃, and doped transition metal oxides selected from Pt/TiO₂ and Pt/TiO₂₋ₓNₓ.

4. The method of claim 1, further comprising a catalyst, wherein said catalyst comprises a metal sulfide together with particles comprising at least one noble metal selected from the group consisting of Pt, Pd, Ir, Ag, Au, Rh and Ru.

5. The method of claim 1, wherein said oxidizing step comprises photooxidation.

6. The method of claim 5, wherein UV or visible light for said photooxidation is provided by solar radiation or by a UV lamp.

7. The method of claim 6, further comprising the steps of:
splitting an infrared portion from a UV and visible light portion of said solar radiation;
directing a UV and visible light portion of said solar radiation to drive said oxidizing step, and
directing said infrared portion to provide at least a portion of heat required for decomposition of ammonium sulfate (NH₄)₂SO₄(aq) or sulfuric acid H₂SO₄(l).

8. The method of claim 1, wherein said oxidizing step proceeds exclusive of any catalyst, said oxidizing step performed in the presence of UV or visible light.

9. The method of claim 8, wherein said oxidizing step comprises photooxidation, further comprising the step of providing electrical energy, wherein said electrical energy is used to generate UV or visible light for said photooxidation.

10. The method of claim 9, wherein said electrical energy is provided by nuclear power, hydroelectric power, solar energy, photovoltaic cells, or wind driven power.

11. The method of claim 1, wherein a product of said oxidizing step is ammonium sulfate, further comprising the steps of:
thermally decomposing said ammonium sulfate to ammonia and sulfur dioxide, and
recovering and recycling said ammonia and sulfur dioxide to react with said water to regenerate said ammonium sulfite.

12. A method of generating oxygen (O₂), comprising the steps of:
providing an ammonium sulfite compound;
oxidizing said ammonium sulfite in the presence of air and water to ammonium sulfate,
generating sulfuric acid from said ammonium sulfate, and
decomposing said sulfuric acid to produce O₂.

13. The method of claim 12, wherein a reaction temperature for said oxidizing is between 275 K and 375 K.

14. A system for generating hydrogen, comprising:
a reaction vessel having an aqueous ammonium sulfite compound therein;
at least one energy source coupled to said reaction vessel for providing energy to drive an oxidation of said ammonium sulfite, wherein hydrogen is produced,
and structure for capturing said hydrogen.

15. The system of claim 14, wherein said energy source provides exclusively electricity.

16. The system of claim 14, further comprising a photocatalyst, wherein said energy source comprises solar radiation or a UV or visible light source.

17. The system of claim 16, further comprising:
a broadband reflective coating for splitting an infrared portion from a UV and visible light portion of said solar radiation, and
optics for directing said UV and visible light portion to drive said oxidizing step, and optics for directing said infrared portion to provide at least a portion of heat required for decomposition of ammonium sulfate or sulfuric acid.

18. The system of claim 14, wherein said energy source comprises a UV or visible light source, and an electrical source for driving said light source.

19. The system of claim 18, said electrical source is powered by nuclear power, hydroelectric power, photovoltaic cells, or wind driven power.
